(19) United States
(12) Patent Application Publication
(10) Pub. No.: US 2016/0364315 A1
(43) Pub. Date: Dec. 15, 2016

(54) FAST DATA RACE DETECTION FOR MULTICORE SYSTEMS

(71) Applicants: Yann-Hang Lee, Tempe, AZ (US); Young Wn Song, Tempe, AZ (US)

(72) Inventors: Yann-Hang Lee, Tempe, AZ (US); Young Wn Song, Tempe, AZ (US)

(73) Assignee: ARIZONA BOARD OF REGENTS ON BEHALF OF ARIZONA STATE UNIVERSITY, Tempe, AZ (US)

(21) Appl. No.: 15/180,483

(22) Filed: Jun. 13, 2016

Related U.S. Application Data
(60) Provisional application No. 62/175,136, filed on Jun. 12, 2015.

(51) Int. Cl. G06F 11/36

(52) U.S. Cl. CPC G06F 11/3604

(57) ABSTRACT

A system and method to parallelize data race detection in multicore machines are disclosed. The system and method does not generally require any change in the underlining system and the same race detection algorithm may be used, such as FastTrack. In general, race detection is separated from application threads to perform data race analysis in worker threads without inter-thread dependencies.

### CROSS REFERENCE TO RELATED APPLICATIONS

This is a non-provisional application that claims benefit to U.S. provisional application Ser. No. 62/175,136 filed on Jun. 12, 2015 which is incorporated by reference in its entirety.

### FIELD

The present disclosure generally relates to multicore machines, and in particular to systems and methods for fast data race detection for multicore machines.

### BACKGROUND

Multithreading technique has been traditionally used for event-driven programs to handle concurrent events. With the prevalence of multi-core architectures, applications can be programmed with multiple threads that run in parallel to take advantage of on-chip multiple CPU cores and to improve program performance. In a multithreaded program, concurrent accesses to shared resource and data structures need to be synchronized to guarantee the correctness of the program. Unfortunately, the use of synchronization primitives and mutex locking operations in multithreaded programs can be problematic and results in subtle concurrency errors. Data race condition, one of the most pernicious concurrency bugs, has caused many incidences, including the Therac-25 medical radiation device, the 2003 Northeast Blackout, and the Nasdaq's FACEBOOK® glitch.

A data race occurs when two different threads access the same memory address concurrently and at least one of the accesses is a write. It is difficult to locate or reproduce data races since they can be exercised or may cause an error only in a particular thread interleaving.

Data race detection techniques can be generally classified into two categories, static or dynamic. Static approaches consider all execution paths and conservatively select candidate variable sets for race detection analysis. Thus, static detectors may find more races than dynamic detectors which examine the paths that are actually executed. However, static detectors may produce excessive number of false alarms which hinders developers focusing on real data races. 81%-90% of data races detected by static detectors were reported as false alarms. Dynamic detectors on the other hand, detect data races based on actual memory accesses during the executions of threads. In the dynamic approaches, a data race is reported when a memory access is not synchronized with the previous access on the memory location.

There are largely two kinds of dynamic approaches based on how to construct synchronizations during thread executions. In Lockset algorithms a set of candidate locks C(v) is maintained for each shared variable v. This lockset indicates the locks which might be used to protect the accesses to the variable. A violation of a specified lock discipline can be detected if the corresponding lockset is empty. The approaches may report false alarms as lock operations are not the only way to synchronize threads and a violation of a lock discipline does not necessarily imply a data race. In the vector-clock-based detectors, synchronizations in thread executions are precisely constructed with the happens-before relation. The approaches do not report false alarms but the detection incur higher overheads in execution time and memory space than the Lockset approaches as the happens-before relation is realized with the use of expensive vector clock operations.

In practice, dynamic detection approaches are often preferred to static detectors due to the soundness of the detection. Nevertheless, the high runtime overhead impedes routine uses of the detection. There have been broadly two approaches to reduce the runtime overhead. The first approach is to reduce the amount of work that is fed into a detection algorithm. Sampling approaches can be efficient but may miss critical data races in a program. DJIT+ has greatly reduced the number of checks for data race analysis with the concept of timeframes. Memory accesses that don't need to be checked can be removed from the detection by various filters. The use of large detection granularity can also reduce the amount of work for data race analysis. RaceTrack uses adaptive granularity in which the detection granularity is changed from array/object to byte/field when a potential data race is detected. In dynamic granularity, starting with byte granularity, detection granularity is adapted by sharing vector clocks with neighboring memory locations. Another approach is to simplify the detection operations. For instance, by the adaptive representation of vector clock, FastTrack reduces the analysis and space overheads from O(n) to nearly O(1).

Despite the recent efforts to reduce the overhead of dynamic race detectors, they still cause a significant slowdown. It is known that the FastTrack detector imposes a slowdown of 97 times on average for a set of C/C++ benchmark programs. For the same benchmark programs, Intel Inspector XE and Valgrind DRD slow down the executions by a factor of 98 times and 150 times, respectively.

With multicore architectures, one promising approach is to increase parallel executions of data race detector. This strategy has been used to parallelize data race detection. In this approach, thread execution is time-sliced and executed in a pipe-lined manner. That is, each thread execution is defined as a series of timeframes and the code blocks in the same time frame for all threads are executed in a designated core. Their parallel detector speeds up the detection and scales well with multiple cores by eliminating lock cost in the detection and by increasing parallel executions. However, the approach relies on a new multithreading paradigm, uniparallelism which is different from the task parallel paradigm supported by typical thread libraries. In addition, it requires modifications on O/S and shared libraries, and rewriting the detection algorithm.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is an illustration showing a high level view of a FastTrack race detection technique when two threads write to a variable x;

FIG. 2 is an illustration showing a case when two threads are used and an address space is divided into two regions with each detector being responsible only for its own address region;

FIG. 3 is a graph showing the CPI measures of race detection programs;

FIG. 4 is a graph showing scaling factors of race detectors where the number of threads is equal to the number of cores;

FIG. 5 is a graph showing the performance comparison with to without a hash filter;

FIG. 6 is a simplified illustration showing an overview of an data race detection system;

FIG. 7A is a simplified illustration showing one embodiment of the data race detection system.

FIG. 7B is a flowchart of a method for data race detection system; and

FIG. 8 is a simplified block diagram of a computer system.

Corresponding reference characters indicate corresponding elements among the view of the drawings. The headings used in the figures do not limit the scope of the claims.

### DETAILED DESCRIPTION

A system and method to parallelize data race detection in multicore machines are disclosed. The system and method does not generally require any change in the underlining system and the same race detection algorithm may be used, such as FastTrack. In general, race detection is separated from application threads to perform data race analysis in worker threads without inter-thread dependencies. Data access information for race analysis is distributed from application threads to worker threads based on memory address. In other words, each worker thread performs data race analysis only for the memory accesses in its own address range. Note that in a conventional race detector, each application thread performs data race analysis for any memory accesses occurred in the thread. The parallelization strategy of the present system and method increases scalability as any number of worker threads are used regardless of application threads. Speedups are attained as the lock operations in the detector program are eliminated, and the executions of worker threads can exploit the spatial locality of accesses.

In one particular embodiment, the system and method uses the FastTrack algorithm employed on an 8-core computer machine. However, it should be appreciated that the embodiments discussed herein may be applied to a machine with any number of cores and utilizing any type of race detection algorithm. The experimental results of the particular embodiment show that when 4 times more cores are used for detection, the parallel version of FastTrack, on average, can speed up the detection by a factor of 3.3 over the original FastTrack detector. Even without additional cores, the parallel FastTrack detector runs 2.2 times faster on average than the original FastTrack detector.

### Vector Clock Based Race Detectors

In vector clock based race detection approaches, a data race is reported when two accesses on a memory location are not defined by the happens-before relation. The happens-before relation is the transitive and smallest relation over the set of memory and synchronization operations. An operation a happens before an operation b (1) if a occurs before b in the same thread, or (2) if a is a release operation of synchronization object (e.g., unlock) and b is the subsequent acquiring operation on the same object (e.g., lock).

A vector clock is an array of logical clocks for all threads. A vector clock is indexed with a thread id and each element of a vector clock contains synchronization or access information for the corresponding thread. For instance, let Ti be a vector clock maintained for thread i, in which the element Tᵢ[j] is the current logical clock for thread j that has been observed by thread i. If there has not been any synchronization from thread j to thread i either directly or transitively, Ti[ⱼ] will keep the initialization value. Similarly a variable X has a write vector clock W_{X} and a read vector clock R_{X}. When a thread i performs a read or write operation on variable X, R_{X}[i] or W_{X}[i] is updated (to be explained later), respectively.

In a vector clock based detector, each thread maintains a vector clock. On a release operation in thread i, the vector clock entry for the thread is incremented, i.e., Tᵢ[i]₊₊. Each synchronization object also maintains a vector clock to convey synchronization information from the releasing thread to the subsequent acquiring thread. At a release operation of object s by thread i, the vector clock for the object s is updated to the element-wise maximum of vector clocks of thread i and object s. Upon the subsequent acquire operation of the object s by thread j, the vector clock for thread j is updated as the element-wise maximum of vector clocks of thread j and object s.

To detect races on memory accesses, each memory location keeps read and write vector clocks. Upon a write to memory location X in thread i, thread i performs element-wise comparison of thread i's vector clock Tᵢ and location X's write vector clock W_{X} to detect a write-write data race. If there is a thread index j that Tᵢ′s element is not greater than W_{X}, such that W_{X}[j]≧Tᵢ[j] and i≠j, a write-write data race is reported for the location X. A read-write race analysis can be similarly performed with the read vector R_{X}. After the data race analysis, the write access on X in thread i is recorded in W_{X} such that W_{X}[i]=Tᵢ[i]. A similar race analysis and vector clock update operation can be done for read accesses.

In the DJIT+ algorithm, an epoch is defined as a code block between two release operations. It has been proved that, if there are multiple accesses to a memory location in an epoch, data race analysis for the first access is enough to detect any possible race at the memory location. With this property, the amount of race analysis can be greatly reduced. Based on DJIT+, the FastTrack algorithm can further reduce the overhead of vector clock operations substantially without any loss of detection precision. The main idea is that there is no need to keep the full representation of vector clocks most of the time for the detection of a possible race at a memory location. FastTrack can reduce the analysis and space overheads of vector clock based race detection from O(ₙ) to nearly O(1), where n is the number of threads.

### Parallel FastTrack Detector

### Overhead and Scalability of FastTrack

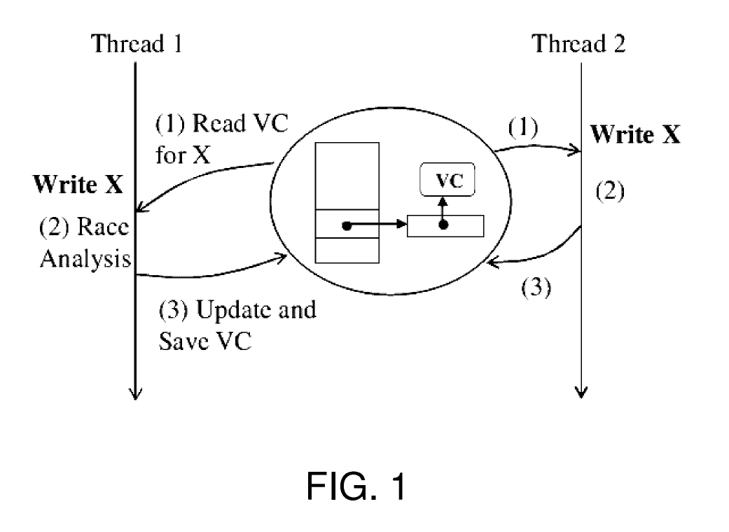

When a thread accesses a memory location, the FastTrack race detector performs the following operations to analyze any data race. First, the vector clocks (for read and write) for the memory location are read from the global data structures. Second, the detection algorithm is applied by comparing the thread's vector clock with the vector clocks for the memory location. Lastly, the vector clocks for the memory location is updated and saved into the global data structures. For example, FIG. 1 illustrates a first thread (Thread 1) 102 that writes to memory location X 106. The operations described above are thus performed by Thread 1 102, namely obtaining the vector clock for the memory location from global data structures 108 (step 1), performing race analysis on the vector clock (step 2), and updating the vector clocks for the memory location (step 3). Similar operations are illustrated for a second thread (Thread 2) 104. However, these operations can lead to excessive overhead. In addition, as the detection is performed when every application thread make references to shared memory, the FastTrack detector incurs substantial runtime overhead and does not scale well in multicore machines

Lock Overhead:

A dynamic race detector is a piece of code that is invoked when the application program issues data references to shared memory. Thus, if the application runs with multiple threads, so does the race detector. In the FastTrack algorithm, vector clocks are read from and updated in global data structures 108 as shown in FIG. 1. When multiple threads access the global data structures 108, the accesses should be synchronized with lock operations at an appropriate granularity. Otherwise, the detector program itself will suffer from concurrency bugs including data races. As lock operations should be applied for every shared memory access, the overhead of race detection can be substantial. As shown in Table 2 of the next section, the locking overhead constitutes on average 17% and can be up to 44% of the execution time of the FastTrack detector.

Inter-Thread Dependency:

During the executions of application threads 102, 104, it is often the case that a thread may be blocked or condition-wait for the resource to be freed by another thread. Hence, CPU cores may not be effectively utilized even with sufficient number of application threads. Since the data race analysis is performed as a part of the execution of application threads, it can suffer from the same inter-thread dependencies as the application threads. Thus, when an application thread is inactive, no data race detection can be done for its memory accesses.

Utilizing Extra Cores:

The prevalence of multicore technologies makes us believe that extra cores will be available for execution of an application. However, if there were more CPU cores than the number of application threads, the race detection may not utilize these extra cores. The number of application threads may be increased to scale up the detection. This can lead to three potential problems. First, increasing the number of application threads may not be beneficial especially if the application is not computation-intensive. Second, changing the number of application threads may imply a different execution behavior including possible data races. Lastly, as shown in our experimental results, the detection embedded in application threads may not scale well when the number of cores increases.

Inefficient Execution of Instructions:

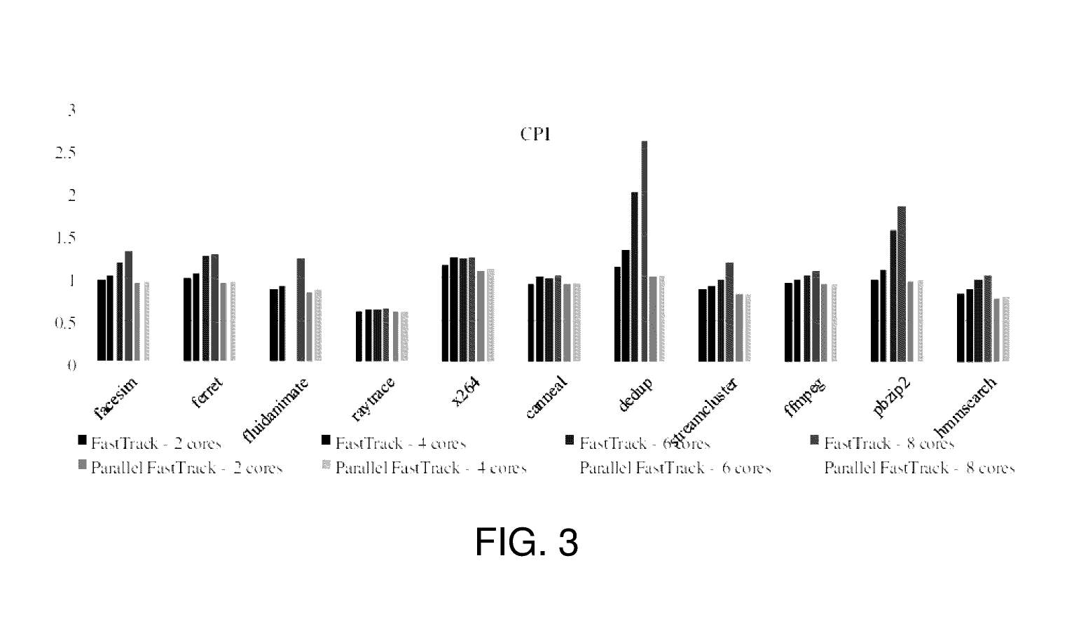

In an execution of the FastTrack detector, global data structures 108 for vector clocks are shared by multiple threads 102, 104, and each application thread is responsible for data race analyses of the memory accesses occurred in the thread. As a consequence, each application thread 102, 104 may access the global data structures 108 whenever it reads or writes shared variables. Thus, the amount of data shared between threads is multiplied, which can result in an increase of the number of cache invalidations. Also, as the working set of each thread is enlarged, the thread execution may experience a low degree of spatial locality and an increase of cache miss ratio. As shown in FIG. 3, this performance penalty will become noticeable as we increase the number of application threads.

### Parallel FastTrack

To cope with the aforementioned problems of race detection on multicore systems, a parallel data race detection system and method is used with which race analyses are decoupled from application threads. The role of an application thread is to record the shared-memory access information needed by race analysis. Additional worker threads are employed to perform data race detection. The worker threads are referred to as detector/detection threads. The key point is to distribute the race analysis workload to detection threads such that (1) a detector's analysis is independent of other detection threads, and (2) the execution of application threads has a minimal impact to the race analyses.

In the FastTrack detector, the same vector clock is shared by multiple threads as the detection for the memory location is performed by the multiple threads. Conversely, the present system and method accesses to one memory location by multiple threads are processed by one detection thread. Assume that the shared memory space is divided into blocks of 2^{C} contiguous bytes and there are n detection threads. Then, accesses to the memory location of address addr by multiple threads are processed by a detection thread T_{d}. The detection thread is decided based on addr as follows,

T_{id}=(addr>>C) mod n−(1)

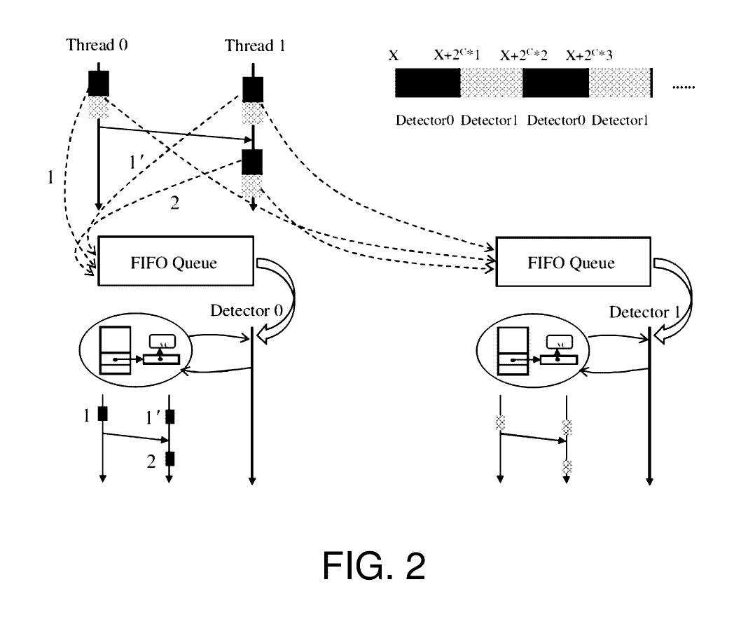

For each detection thread, a FIFO queue is maintained. Upon a shared memory access of address addr, access information needed by the FastTrack race detection should be sent to the FIFO queue of detector T_{id}. Since the queue is shared by application threads and the detector, accesses to the queue should be synchronized. To minimize the synchronization, each application thread saves temporarily a chunk of access information in a local buffer for each detection thread. When the buffer is full or a synchronization operation occurs in the thread, then the pointer of the buffer is inserted to the queue and new buffer is created to save subsequent access information. Other than memory access information, execution information of a thread such as synchronization and thread creation/join is also sent to the queue. At the detector side, the pointers of the buffers are retrieved from the queue and the thread execution information is read from the buffer to perform data race analysis using the same FastTrack detection approach. An overview of the approach is shown in FIG. 2.

The distribution of access information does not break the order of race analyses if the accesses already follow the happens-before relation. The order is naturally preserved by the use of the FIFO queues and synchronizations in the application threads. On the other hand, if the accesses are concurrent, they can be analyzed in any order for a detection of race. As an example, consider the access chunks sent to detector thread 0 202 in FIG. 2. The access chunk 1 is inserted into the queue 203 before the release operation in application thread 0 204 and the access chunk 2 can appear in the queue only after the synchronization acquire in application thread 1 206. Therefore, the order of analyses in detector thread 0 202 will be preserved as if the analyses are done in the application threads. The same can be said of detector thread 1 208 that operates in a similar manner.

The parallel FastTrack detector has an improved performance and scalability over the original version of FastTrack in a number of ways. First, as accesses to a memory location by multiple threads are handled by one detector, lock operations in the detection can be eliminated. Second, the race detection becomes less dependent on the application threads' execution than in the original FastTrack detector. Even when multiple application threads are inactive (e.g., condition waiting), the detector threads can proceed with the race analysis and utilize any available cores. Third, the detection operation can scale well even for the applications consisting of less number of threads than the number of available cores. Lastly, cache performance will be improved and there will be less data sharing. If there are n detection threads, each detector will be responsible for 1/n of the shared address space, and each detector does not share the data structures of vector clock with other detectors.

### Implementation

One embodiment of the FastTrack detector may be implemented for data race detection of C/C++ programs and Intel PIN 2.11 is used for dynamic binary instrumentation of programs. To trace all shared memory accesses, every data access operation is instrumented. A subset of function calls is also instrumented to trace thread creation-join, synchronization, and memory allocation/de-allocation. In the FastTrack algorithm, to check same epoch accesses, vector clocks should be read from global data structures with a lock operation. In our original FastTrack implementation, we adopt a per-thread bitmap at each application thread to localize the same epoch checking and to remove the need of lock operations. Thus, only the first access in an epoch needs to be analyzed for a possible race. Even with this enhancement, the lock cost in the FastTrack detector is still considerably high as our experimental results show. Before any access information is fed into the FastTrack detector, we have applied two additional filters to remove unnecessary analyses. First, we filter out stack accesses assuming that there is no stack sharing. Second, a hash filter is applied to remove consecutive assesses to an identical location. The second filter is a small hash-table like array that is indexed with lower bits of memory address and remembers only the last access for each array element. In PIN, a function can be in-lined into instrumented code as long as it is a simple basic block. To enhance the performance of instrumentation, an analysis function, written in a basic block, is used to apply the two filters, and put the access information into a per-thread buffer. When the buffer is full a non-inline function is invoked for data race analyses for the accesses in the buffer.

The race analysis routine for every memory access for the parallel FastTrack is identical to the original FastTrack except the buffering of accesses. Instead of the per-thread buffer at each application thread, there is a buffer for each detection thread. That is, for every memory access, the detector thread is chosen based on the address of the access and the access information is routed to the corresponding buffer. When the buffer is full or there is a synchronization operation, the buffer is inserted into the FIFO queue of the detector thread. For the FastTrack race detection, a tuple of {thread id, VC (Vector Clock), address, size, IP (Instruction Pointer), access type} is needed for each memory access. Since {thread id, VC} can be shared by multiple accesses in the same epoch, only the tuple of {address, size, IP, access type} is recoded into the buffer.

TABLE 1
Number of accesses filtered and checked in
the FastTrack detection (8 cores with 8 threads).

| | Number of accesses (million) | | | |
|---|---|---|---|---|
| | | | | After the |
| Benchmark | | After stack | After hash | same epoch |
| Program | All | filter | filter | check |
| facesim | 8,671 | 7,586 | 5,096 | 2,397 |
| ferret | 6,797 | 4,110 | 2,174 | 896 |
| fluidanimate | 10,184 | 9,870 | 4,674 | 2,171 |
| raytrace | 9,208 | 2,276 | 865 | 104 |
| x264 | 4,776 | 4,028 | 2,369 | 257 |
| canneal | 2,714 | 3,668 | 903 | 16 |
| dedup | 10,793 | 10,687 | 3,938 | 1,797 |
| streamcluster | 19,540 | 17,720 | 7,888 | 4,026 |
| ffmpeg | 10,279 | 9,960 | 6,408 | 990 |
| pbzip2 | 7,567 | 7,253 | 4,154 | 344 |
| hmmsearch | 21,912 | 6,579 | 3,241 | 1,308 |

TABLE 2
The overheads of the FastTrack detector (8 cores with 8
threads).

| | Overhead (sec) | | | | | | |
|---|---|---|---|---|---|---|---|
| | | | | | | | % of |
| Bench- | | | Same | | | | lock |
| mark | | | epoch | | | | over- |
| Program | PIN | Filtering | check | Lock | FastTrack | Total | head |
| faceism | 22.4 | 32.1 | 67.4 | 89.6 | 245.5 | 457.0 | 19.6% |
| ferret | 14.4 | 11.8 | 18.3 | 39.1 | 140.5 | 224.0 | 17.4% |
| fluid- | 9.2 | 18.4 | 43.2 | 68.8 | 92.3 | 232.0 | 29.7% |
| animate | | | | | | | |
| raytrace | 15.1 | 19.0 | 3.3 | 1.7 | 3.0 | 42.0 | 4.0% |
| x264 | 10.3 | 12.1 | 13.5 | 18.8 | 67.2 | 122.0 | 15.4% |
| canneal | 9.4 | 8.1 | 8.9 | 0.2 | 2.4 | 29.0 | 0.6% |
| dedup | 15.3 | 17.0 | 39.1 | 62.2 | 454.4 | 588.0 | 10.6% |
| stream- | 9.2 | 11.8 | 47.6 | 125.9 | 94.5 | 289.0 | 43.6% |
| cluster | | | | | | | |
| ffmpeg | 25.8 | 0.0 | 139.7 | 64.3 | 170.2 | 400.0 | 16.1% |
| pbzip2 | 7.5 | 12.4 | 13.6 | 6.8 | 77.7 | 118.0 | 5.8% |
| hmmsearch | 14.2 | 30.3 | 31.5 | 66.8 | 131.2 | 274.0 | 24.4% |
| Average | | | | | | | 17.0% |

### Evaluation

In this section, experimental results on the performance and scalability of our parallel FastTrack detection are disclosed. First, the overhead analysis of the FastTrack detection is shown to clarify why the FastTrack detection is slow and does not scale well on multicore machines, and how the parallel version of FastTrack alleviates the overhead. Second, the performance and scalability of the FastTrack and parallel FastTrack detections are compared. All experiments were performed on an 8-core workstation with 2 quad-core 2.27 GHz Intel Xeon running Red Hat Enterprise 6.6 with 12 GB of RAM. The experiments were performed with 11 benchmark programs, 8 from the PARSEC-2.1 benchmark suite and 3 from popular multithreaded applications: FFmpeg which is a multimedia encoder/decoder, pbzip2 as a parallel version of bzip2, and hmmsearch which performs sequence search in bioinformatics. In the following subsections, the number of application threads that carry out the computation is controllable through a command-line parameter. For the parallel FastTrack detection, the number of detection threads is set to the number of cores for all cases.

TABLE 3
CPU core utilization

| | 2 cores | | | 4 cores | | | 6 cores | | | | | |
|---|---|---|---|---|---|---|---|---|---|---|---|---|
| | 2 application threads | | | 4 application threads | | | 6 application threads | | | 8 cores | | |
| Benchmark | Appli- | | | Appli- | | | Appli- | | | 8 application threads | | |
| Program | cation | FastTrack | Parallel | cation | FastTrack | Parallel | cation | FastTrack | Parallel | Application | FastTrack | Parallel |
| facesim | 77% | 76% | 92% | 54% | 55% | 87% | 39% | 46% | 78% | 33% | 41% | 72% |
| ferret | 88% | 85% | 88% | 85% | 79% | 85% | 81% | 53% | 81% | 77% | 40% | 75% |
| fluidanimate | 92% | 89% | 87% | 86% | 81% | 87% | N/A | N/A | N/A | 69% | 73% | 77% |
| raytrace | 96% | 89% | 84% | 89% | 77% | 73% | 84% | 67% | 63% | 83% | 60% | 56% |
| x264 | 87% | 94% | 87% | 86% | 90% | 81% | 81% | 82% | 71% | 73% | 66% | 60% |
| canneal | 89% | 84% | 79% | 78% | 70% | 64% | 66% | 56% | 51% | 62% | 51% | 44% |
| dedup | 77% | 91% | 92% | 59% | 83% | 91% | 37% | 62% | 87% | 37% | 72% | 85% |
| steamcluster | 96% | 95% | 92% | 95% | 87% | 91% | 91% | 68% | 90% | 76% | 77% | 86% |
| ffmpeg | 62% | 72% | 89% | 46% | 48% | 88% | 38% | 36% | 79% | 28% | 29% | 72% |
| pbzip2 | 97% | 96% | 87% | 96% | 94% | 90% | 96% | 93% | 88% | 94% | 91% | 85% |
| hmmsearch | 99% | 87% | 84% | 98% | 67% | 91% | 99% | 55% | 91% | 98% | 46% | 89% |
| Average | 87% | 87% | 87% | 79% | 75% | 85% | 71% | 62% | 78% | 66% | 59% | 73% |

TABLE 4
Performance comparisons of the FastTrack and the parallel FastTrack detections. The number
of applications threads and detection threads are set to the number of cores.

| | 2 cores (sec) | | | | 4 cores (sec) | | | | 6 cores (sec) | | | | 8 cores (sec) | | | |
|---|---|---|---|---|---|---|---|---|---|---|---|---|---|---|---|---|
| Benchmark | Appli- | Fast- | Par- | Speed- | Appli- | Fast- | Par- | Speed- | Appli- | Fast- | Par- | Speed- | Appli- | Fast- | Par- | Speed- |
| Program | cation | Track | allel | up | cation | Track | allel | up | cation | Track | allel | up | cation | Track | allel | up |
| facesim | 5.5 | 718 | 461 | 1.6 | 3.9 | 519 | 251 | 2.1 | 3.4 | 484 | 194 | 2.5 | 3.2 | 457 | 154 | 3.0 |
| ferret | 5.4 | 304 | 247 | 1.2 | 2.9 | 192 | 133 | 1.4 | 2.1 | 228 | 102 | 2.2 | 1.6 | 224 | 83 | 2.7 |
| fluidanimate | 6.5 | 313 | 254 | 1.2 | 3.5 | 220 | 161 | 1.4 | — | — | — | — | 2.2 | 232 | 155 | 1.5 |
| raytrace | 9.4 | 105 | 104 | 1.0 | 5.2 | 63 | 62 | 1.0 | 3.6 | 49 | 54 | 0.9 | 2.9 | 42 | 42 | 1.0 |
| x264 | 3.4 | 239 | 224 | 1.1 | 1.9 | 145 | 133 | 1.1 | 1.3 | 125 | 117 | 1.1 | 1.1 | 122 | 98 | 1.2 |
| canneal | 8.1 | 60 | 61 | 1.0 | 4.8 | 39 | 40 | 1.0 | 3.8 | 33 | 36 | 0.9 | 3.2 | 29 | 31 | 0.9 |
| dedup | 8.7 | 719 | 562 | 1.3 | 5.8 | 482 | 298 | 1.6 | 6.4 | 671 | 208 | 3.2 | 4.8 | 588 | 159 | 3.7 |
| steamcluster | 4.3 | 632 | 431 | 1.5 | 2.3 | 372 | 238 | 1.6 | 1.3 | 392 | 174 | 2.3 | 1.0 | 289 | 143 | 2.0 |
| ffmpeg | 6.2 | 563 | 379 | 1.5 | 4.4 | 434 | 198 | 2.2 | 3.9 | 407 | 159 | 2.6 | 3.7 | 400 | 127 | 3.1 |
| pbzip2 | 5.7 | 219 | 208 | 1.1 | 3.1 | 128 | 109 | 1.2 | 2.0 | 128 | 77 | 1.7 | 1.6 | 118 | 59 | 2.0 |
| hmmsearch | 5.8 | 443 | 348 | 1.3 | 2.9 | 309 | 178 | 1.7 | 2.0 | 285 | 132 | 2.2 | 1.5 | 274 | 92 | 3.0 |
| Average | | | | 1.2 | | | | 1.5 | | | | 1.9 | | | | 2.2 |

### Analysis of Race Detection Execution

Table 1 shows the number of accesses that are filtered by the two filters and checked by the FastTrack algorithm. The “All” column shows the number of instrumentation function calls invoked by memory accesses. “After stack filter” and “After hash filter” columns show the number of accesses after the stack and hash filters, respectively. The last column shows the number of accesses after removing the same epoch accesses with the per-thread bitmap. The last column represents accesses that are fed into the race analysis of FastTrack algorithm, and we can expect that the lock cost will be proportional to the number in this column for each benchmark application.

Table 2 presents the overhead analysis of the FastTrack detection for running on 8 cores with 8 application threads. “PIN” column shows the time spent in PIN instrumentation function with-out any analysis code. The execution time of filtering access and saving access information into the per-thread buffer is presented in “Filtering” column. The two columns signify the amount of time that cannot be parallelized by our approach as they should be done in application threads, and the scalability of our parallel detector will be limited by sum of the two columns. The lock cost, shown in the “Lock” column, is extracted from the runs with locking and unlocking operations, but with no processing on vector clocks. The measure may not be very accurate due to the possible lock contention. However, it will still show a basic idea of how significant the lock overhead is. The overhead of locking is 17%, on average and it is up to 44% of the total execution time for steam cluster benchmark program. With the number of application threads equals to the number of cores, the average lock overheads on the systems of 2, 4, and 6 cores are 14.1%, 14.7%, and 15.2%, respectively. These overheads follow the similar pattern as the overheads shown in the table for an 8 cores system, and the results are omitted for the simplicity of the discussion.

In FIG. 3, we present the CPI (Cycles per Instruction) measures from the FastTrack and our parallel FastTrack detector runs. The CPI measures indirectly show the cache performance as cache misses and invalidations can lead to memory stalls. The CPIs are measured with Intel Amplifier-XE. For each benchmark program in FIG. 3, the first four columns represent the CPIs of the FastTrack detector running on machines of 2, 4, 6, and 8 cores. The second four columns indicate the CPIs of the parallel FastTrack detector on the same machine configurations. For all cases, the number of application threads is equal to the number of cores. Since the benchmark program fluidanimate can only be configured with 2n threads, the performance measures of fluidanimate with 6 application threads are not reported throughout the paper.

TABLE 5
The speedups with additional cores. For all cases,
two application threads are used.

| | Appli- | | Parallel FastTrack (sec) | | | |
|---|---|---|---|---|---|---|
| | cation | | # of detectors = # of cores | | | |
| Benchmark | 2 cores | FastTrack | 2 | 4 | 6 | 8 |
| program | (sec) | 2 cores (sec) | cores | cores | cores | cores |
| facesim | 5.5 | 718 | 461 | 249 | 194 | 156 |
| ferret | 5.4 | 304 | 247 | 129 | 97 | 79 |
| fluidanimate | 6.5 | 313 | 254 | 139 | 125 | 112 |
| raytrace | 9.4 | 105 | 104 | 83 | 97 | 83 |
| x264 | 3.4 | 239 | 224 | 127 | 100 | 81 |
| canneal | 8.1 | 60 | 61 | 44 | 48 | 43 |
| dedup | 8.7 | 719 | 562 | 291 | 197 | 150 |
| steamcluster | 4.3 | 632 | 431 | 227 | 159 | 118 |
| ffmpeg | 6.2 | 563 | 379 | 197 | 176 | 142 |
| pbzip2 | 5.7 | 219 | 208 | 108 | 88 | 75 |
| hmmsearch | 5.8 | 443 | 348 | 184 | 204 | 165 |

The results in FIG. 3 suggest that the CPIs of the FastTrack detection are higher than those of the parallel FastTrack detection. It is notable that, in the FastTrack detection, the CPI increases as we increase the number of application threads and the number of cores. That is due to the data sharing across the cores that may result in cache invalidation and memory access stalls. Note that, in the FastTrack detection, the vector clocks are organized in a glob-al data structure and shared among all running threads. Locking operations, which need to flush the CPU pipeline, can also lead to a negative impact on the CPI. The increased CPI not only hurts the performance of race detection, but makes the detection not scalable. For the two programs, dedup and pbzip2, we can expect that the performance of the FastTrack detection would not be improved even with additional cores. On the contrary, the CPIs of the parallel FastTrack detector are stable as we change the number of cores. The detection thread performs data race analyses for an independent range of the address space and they don't share vector clocks with other detectors.

In Table 3, the CPU core utilizations, measured with Intel Amplifier-XE, are reported. For each machine configuration, the experiments include running benchmark applications alone, benchmark applications with FastTrack detection and with parallel FastTrack detection. In general, we can observe that, when the applications cannot fully utilize the cores, adding the processing of the FastTrack detection would not improve CPU utilization. On the other hand, the core utilization is improved under the parallel detection regardless of the executions of application threads. For instance, for facesim, ferret, and ffmpeg on an 8 core machine, the parallel detection nearly doubles the CPU core utilization of the FastTrack detection.

Ideally, the execution of the parallel FastTrack detector should utilize 100% of cores. There are largely two reasons why the parallel detection does not fully utilize the cores. First, application threads may not be fast enough in generating access information into the queues to make the detection threads busy. In other words, the queues become empty and the detection threads become idle. In the cases of raytrace and canneal, the applications use a single thread to process input data during the initialization of the programs. In our implementation of race detection, we disable race detection when only one thread is active. Hence, during the initialization process, all detection threads are idle. Also, a large amount of stack accesses can cause the detection threads idle since all the stack accesses are filtered out by the instrumentation code of the application threads.

The other reason is due to the serialization between application threads and the detection threads. To reduce the overhead, access information from an application thread is saved in a buffer (the size of 100 k access entries in the current implementation) and is transferred to a detector when the buffer is full. However, when a synchronization event occurs during application execution, the buffer is moved into the queue immediately. Thus, frequent synchronization events in application threads can serialize the FIFO queue operations with detection threads.

### Performance and Scalability

The performance results for the executions of the parallel and FastTrack detectors are compared and shown in Table 4. The experiments were performed on the machines of 2 to 8 cores and the number of application threads is equal to the number of cores. In addition to the execution times, the speedup factor of the parallel detection over the FastTrack detection is included in the table.

Overall, the parallel detector performs much better than the FastTrack detector. This performance improvement is attributed to three factors: (1) the overhead of lock operations in race analyses, as shown in Table 2, is eliminated, (2) the parallel detection better utilizes multiple cores as presented in Table 3, and (3) the localized data structure in detection threads reduces global data sharing and improves CPI, as shown in FIG. 3. In addition, the speed-up factors of Table 4 (i.e., the ratio of execution time of the FastTrack detector to that of the parallel detector) increase with the number of cores. This is caused by the enhancements in core utilizations and CPIs when the parallel detection is executed on multicore machines.

While the parallel detector achieves a speed-up factor of 2.2 on average over the FastTrack detection on an 8 core machine, some programs, such as raytrace, canneal in the experiments, don't gain any speed-up with the parallel detection. As described in the previous subsection, the two programs run with a single application thread for a long period of time, and there are relatively small amount of accesses that must be checked by the FastTrack algorithm (as shown in the last column of Table 1).

TABLE 6
The maximal memory usage of FastTrack and parallel FastTrack race detections

| | 2 core | | | 4 core | | | 6 core | | | | | |
|---|---|---|---|---|---|---|---|---|---|---|---|---|
| | 2 application threads | | | 4 application threads | | | 6 application threads | | | 8 core | | |
| | (MB) | | | (MB) | | | (MB) | | | 8 application threads | | |
| Benchmark | Appli- | | | Appli- | | | Appli- | | | (MB) | | |
| Program | cation | FastTrack | Parallel | cation | FastTrack | Parallel | cation | FastTrack | Parallel | Application | FastTrack | Parallel |
| facesim | 417 | 5137 | 5950 | 576 | 5450 | 6682 | 730 | 5600 | 7613 | 888 | 5810 | 7756 |
| ferret | 759 | 7011 | 5638 | 1365 | 8091 | 6624 | 1971 | 8900 | 7768 | 2577 | 10032 | 9506 |
| fluidanimate | 267 | 1362 | 2253 | 290 | 1440 | 2408 | — | — | — | 338 | 1605 | 3088 |
| raytrace | 80 | 741 | 1142 | 101 | 811 | 1746 | 121 | 878 | 1870 | 142 | 949 | 2651 |
| x264 | 135 | 4282 | 4531 | 165 | 4092 | 7757 | 195 | 6530 | 11247 | 225 | 8292 | 13736 |
| canneal | 207 | 861 | 1380 | 359 | 1085 | 1785 | 510 | 1319 | 2219 | 662 | 1572 | 2616 |
| dedup | 2717 | 8265 | 7018 | 2709 | 8823 | 8069 | 3026 | 9175 | 8512 | 3371 | 9829 | 9409 |
| steamcluster | 110 | 668 | 1182 | 131 | 692 | 1424 | 151 | 761 | 1696 | 172 | 821 | 2037 |
| ffmpeg | 147 | 1519 | 2317 | 229 | 1746 | 4697 | 312 | 1968 | 3330 | 395 | 2239 | 3778 |
| pbzip2 | 217 | 3914 | 4318 | 380 | 4497 | 4781 | 557 | 5078 | 5146 | 726 | 3912 | 6114 |
| hmmsearch | 161 | 599 | 1047 | 312 | 806 | 1406 | 464 | 1006 | 1676 | 615 | 1206 | 2529 |
| Average | 474 | 3124 | 3343 | 601 | 3412 | 4089 | 804 | 4122 | 5108 | 919 | 4206 | 5747 |

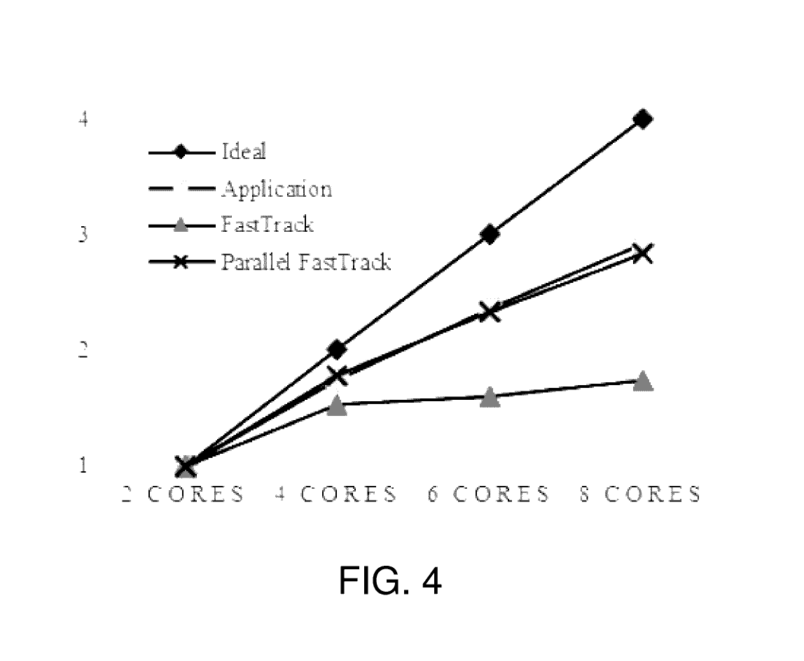

Another view for the performance results of Table 4 is depicted in FIG. 4 where the speed-up factors are drawn from 2 cores to 8 cores for application alone, the FastTrack detection, and the parallel detection. For comparison, the ideal speedup is added in the figure. The figure suggests that the parallel FastTrack detector can scale up when we increase the number of cores in the systems. On the other hand, the FastTrack detector does not scale well due to the reasons explained previously.

In Table 5, we present the performance of parallel race detector when additional cores are available. Only two application threads are used for all the experiments in Table 5. As we increase the number of cores from 2 to 8, 6 additional cores can be used to run the detection threads in the parallel race detector. Note that the executions of application itself and the FastTrack detection obviously do not change since the number of application threads is fixed. On the other hand, the parallel FastTrack detector, that utilizes all additional 6 cores, produces an average speed-up of 3.3 when the performance of the parallel detection and the FastTrack detection is compared. This speedup is due to the effective execution of parallel detection threads that is separated from the application execution.

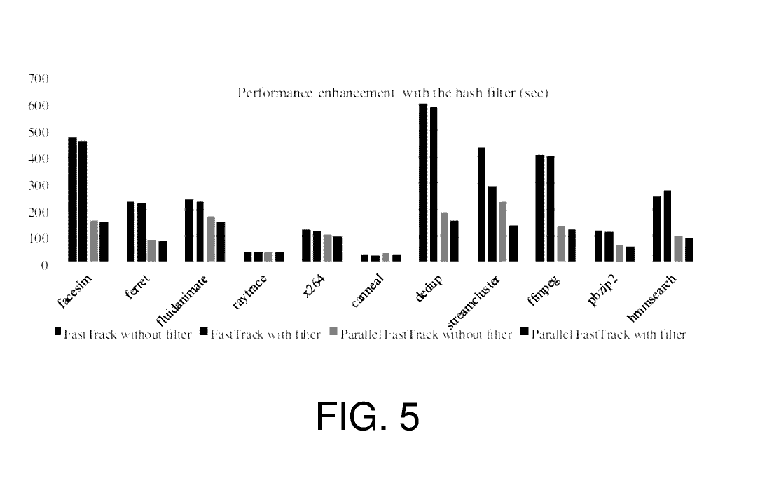

FIG. 5 shows the performance enhancement with the hash filter. On average, the hash filter brings about 5% and 10% performance improvements for the FastTrack and parallel FastTrack detectors. In our current implementation, each thread maintains hash filters of 512 and 256 entries for read and write accesses, respectively. We found out that, while an increase of the hash filter, more accesses can be removed from the checking of the same epoch access. However, there were performance penalties in cache accesses as the arrays of the hash filter are randomly accessed. There are significant performance enhancements for certain benchmark programs. For instance, in streamcluster, the performance gain due to the hash filter is 33% for the FastTrack detector and 38% for the parallel detector. This application frequently spins on flag variables and generates a substantial amount of accesses to few memory locations during short intervals. Thus, the hash filter can effective remove the duplicated accesses and improve the performance greatly. The use of the hash filter in the parallel detection can not only save redundant race analysis but also avoid the transfer of access information through the FIFO queue.

Table 6 illustrates the maximum memory used during the executions of the application, the FastTrack detector, and the parallel detector. For the executions on an 8 cores machine (there are 8 detection threads), the parallel detector uses on average 1.37 times more memory than the FastTrack detector. As the number of detection threads is increased, it is expected that additional memory is consumed by the buffers and queues to distribute access information from application threads to detection threads.

### Overview

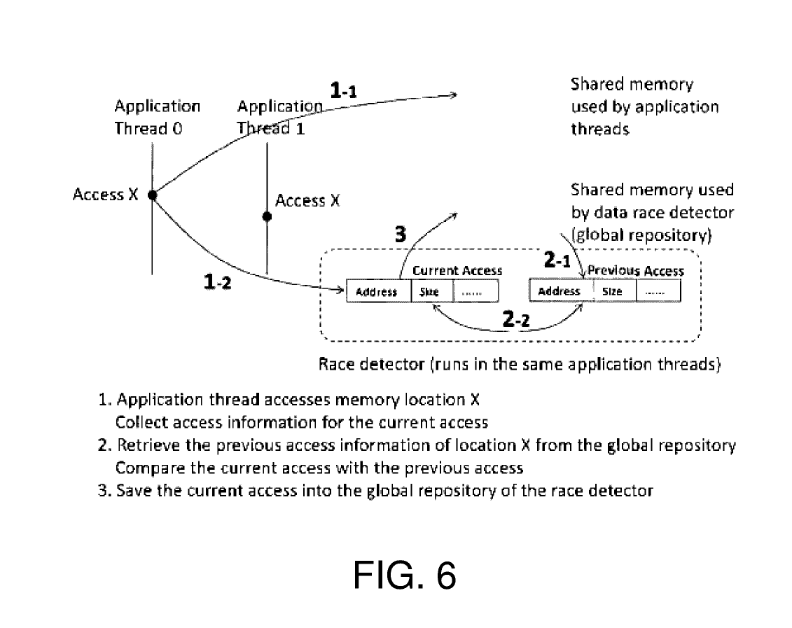

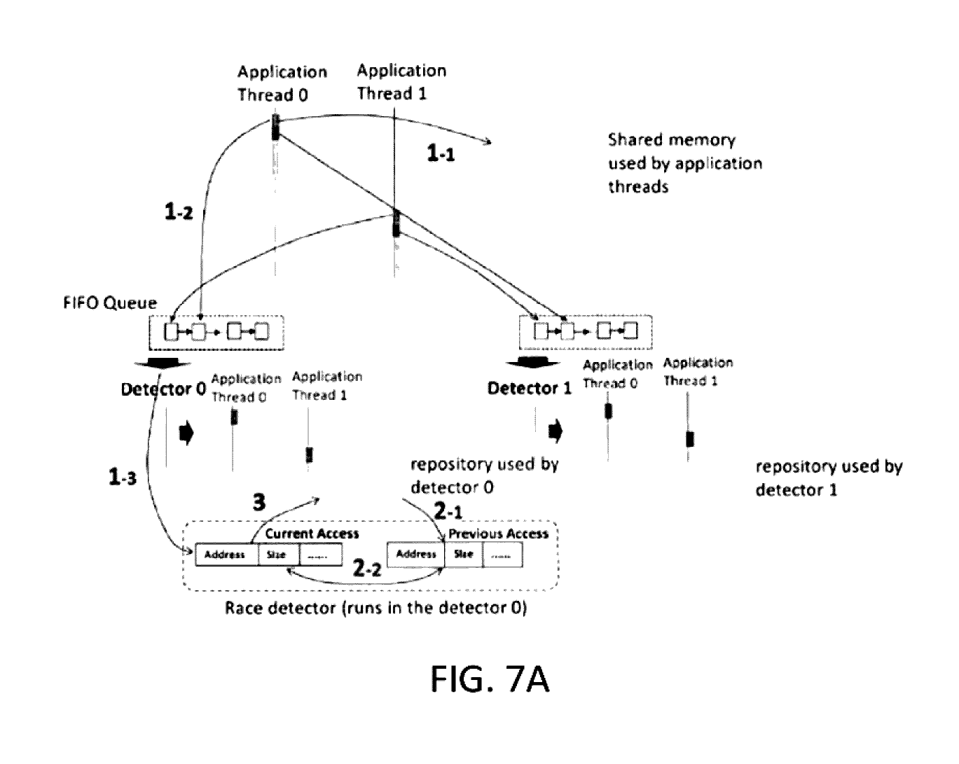

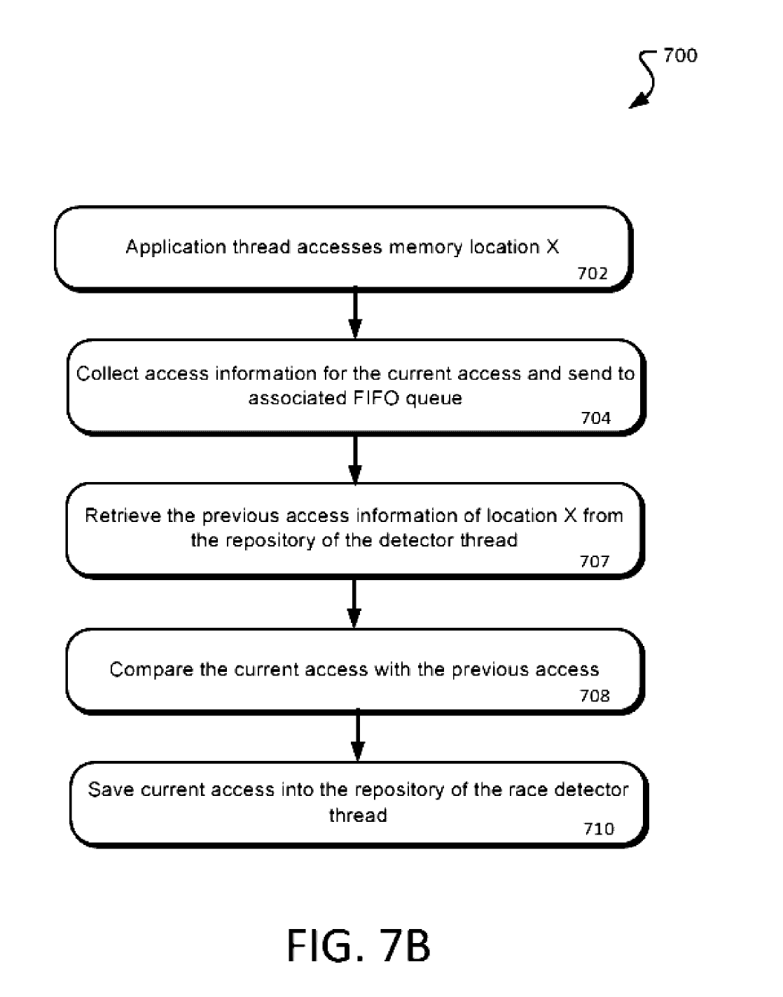

In one method for implementing the race detection system, additional threads are created before the application thread starts. The number of detection threads may be equal to the number of central processing units in the computer. A First-In-First-Out (FIFO) queue is then created for each thread. When a memory location is accessed by an application thread, the access information is distributed to the associated FIFO queue and the detection thread takes the access history from the FIFO queue to perform data race detection for the access. FIG. 7A shows an embodiment of the data race detection of the system. A flowchart of the method 700 of the embodiment is illustrated in FIG. 7B. The steps are similar to the ones explained with respect to FIG. 6 except the use of the global repository for the data race detection is not used. Beginning in operation 702, an application thread accesses memory location X, collects access information for the current access and the information is sent to the associated FIFO queue in operation 704. The associated detector takes the current access information from the FIFO queue. In operation 706, the previous access information of location X is retrieved from the repository of the detector thread and then compared the current access with the previous access in operation 708. The next step is to save the current access into the repository of the detector thread in operation 710. Note that the devised race detection method, the global repository shared by multiple application threads is not used. Instead, the local repository for each detection thread is used. Therefore, the data race detection does not use lock operations to access the repository. For instance, as shown in FIGS. 7A and 7B, the memory accesses on the blue range are all handled by the detection thread 0. On the other hand, in the existing techniques, the memory accesses are handled by multiple threads (See FIG. 6).

In another method for implementing the race detection system, the access information is distributed to the associated detection thread. The associated detection thread is determined by the memory space is divided into blocks of 2^{C} contiguous bytes and there are n detection threads. The memory access information of address X is associated with the detection thread T_{id} where T_{id}=(X>>C) % n, wherein >> is the right shift operator and % is the modulus operator). The aforementioned formula, T_{id}=(X>>C) % n, ensures that each block is examined by one detector.

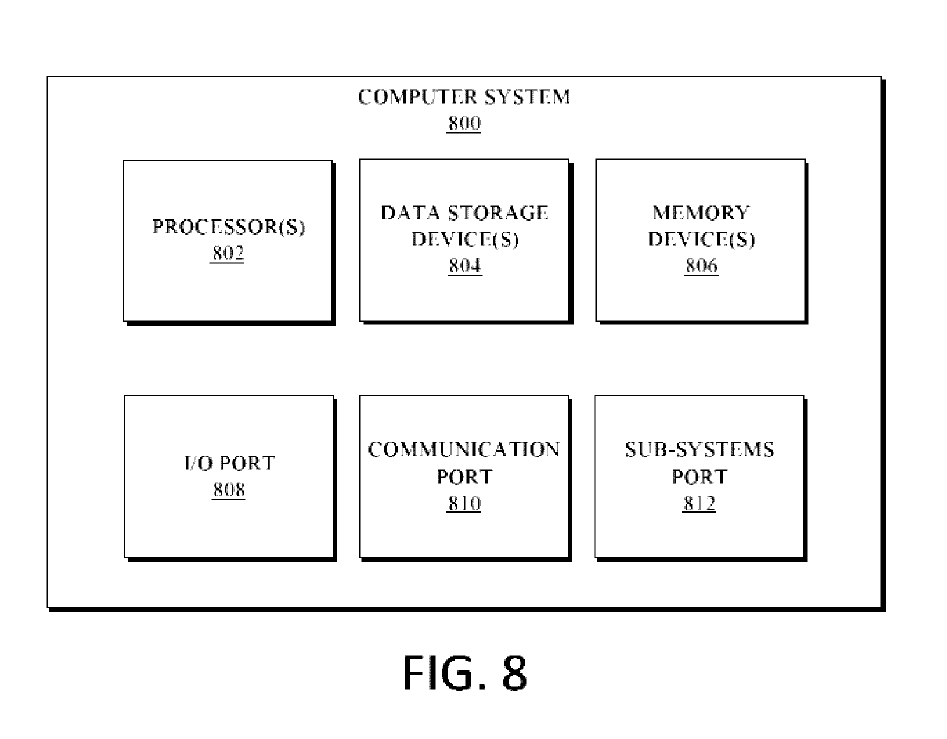

Referring to FIG. 8, a detailed description of an example computing system 800 having one or more computing units that may implement various systems and methods discussed herein is provided. The computing system 800 may be applicable to the multi-core system discussed herein and other computing or network devices. It will be appreciated that specific implementations of these devices may be of differing possible specific computing architectures not all of which are specifically discussed herein but will be understood by those of ordinary skill in the art.

The computer system 800 may be a computing system is capable of executing a computer program product to execute a computer process. Data and program files may be input to the computer system 800, which reads the files and executes the programs therein. Some of the elements of the computer system 800 are shown in FIG. 8, including one or more hardware processors 802, one or more data storage devices 804, one or more memory devices 806, and/or one or more ports 808-812. Additionally, other elements that will be recognized by those skilled in the art may be included in the computing system 800 but are not explicitly depicted in FIG. 8 or discussed further herein. Various elements of the computer system 800 may communicate with one another by way of one or more communication buses, point-to-point communication paths, or other communication means not explicitly depicted in FIG. 8.

The processor 802 may include, for example, a central processing unit (CPU), a microprocessor, a microcontroller, a digital signal processor (DSP), and/or one or more internal levels of cache. There may be one or more processors 802, such that the processor comprises a single central-processing unit, or a plurality of processing units capable of executing instructions and performing operations in parallel with each other, commonly referred to as a parallel processing environment.

The computer system 800 may be a conventional computer, a distributed computer, or any other type of computer, such as one or more external computers made available via a cloud computing architecture. The presently described technology is optionally implemented in software stored on the data stored device(s) 804, stored on the memory device(s) 806, and/or communicated via one or more of the ports 808-812, thereby transforming the computer system 800 in FIG. 8 to a special purpose machine for implementing the operations described herein. Examples of the computer system 800 include personal computers, terminals, workstations, mobile phones, tablets, laptops, personal computers, multimedia consoles, gaming consoles, set top boxes, and the like.

The one or more data storage devices 804 may include any non-volatile data storage device capable of storing data generated or employed within the computing system 800, such as computer executable instructions for performing a computer process, which may include instructions of both application programs and an operating system (OS) that manages the various components of the computing system 800. The data storage devices 804 may include, without limitation, magnetic disk drives, optical disk drives, solid state drives (SSDs), flash drives, and the like. The data storage devices 804 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 806 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 804 and/or the memory devices 806, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computer system 800 includes one or more ports, such as an input/output (I/O) port 808, a communication port 810, and a sub-systems port 812, for communicating with other computing, network, or vehicle devices. It will be appreciated that the ports 808-812 may be combined or separate and that more or fewer ports may be included in the computer system 800.

The I/O port 808 may be connected to an I/O device, or other device, by which information is input to or output from the computing system 800. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing system 800 via the I/O port 808. Similarly, the output devices may convert electrical signals received from computing system 800 via the I/O port 808 into signals that may be sensed as output by a human, such as sound, light, and/or touch. The input device may be an alphanumeric input device, including alphanumeric and other keys for communicating information and/or command selections to the processor 802 via the I/O port 808. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

In one implementation, a communication port 810 is connected to a network by way of which the computer system 800 may receive network data useful in executing the methods and systems set out herein as well as transmitting information and network configuration changes determined thereby. Stated differently, the communication port 810 connects the computer system 800 to one or more communication interface devices configured to transmit and/or receive information between the computing system 800 and other devices by way of one or more wired or wireless communication networks or connections. For example, the computer system 800 may be instructed to access information stored in a public network, such as the Internet. The computer 800 may then utilize the communication port to access one or more publicly available servers that store information in the public network. In one particular embodiment, the computer system 800 uses an Internet browser program to access a publicly available website. The website is hosted on one or more storage servers accessible through the public network. Once accessed, data stored on the one or more storage servers may be obtained or retrieved and stored in the memory device(s) 806 of the computer system 800 for use by the various modules and units of the system, as described herein.

Examples of types of networks or connections of the computer system 800 include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 810 to communicate one or more other machines, either directly over a point-to-point communication path, over a wide area network (WAN) (e.g., the Internet), over a local area network (LAN), over a cellular (e.g., third generation (3G) or fourth generation (4G)) network, or over another communication means. Further, the communication port 810 may communicate with an antenna for electromagnetic signal transmission and/or reception.

The computer system 800 may include a sub-systems port 812 for communicating with one or more additional systems to perform the operations described herein. For example, the computer system 800 may communicate through the sub-systems port 812 with a large processing system to perform one or more of the calculations discussed above.

The system set forth in FIG. 8 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A method for parallelize data race detection in a multi-core computing machine, the method comprising:
creating one or more detection threads within the multi-core computing machine;
generating a queue for each of the one or more created detection threads;
upon accessing of a particular memory location within a memory device of the multi-core computing machine by an application thread of the multi-core computing machine, distributing access information into the queue for a particular detection thread of the one or more detection threads; and
utilizing the particular detection thread to retrieve the access information from the queue for the particular detection thread.

2. The method of claim 1 wherein the queue is a local repository associated with the particular detection thread.

3. The method of claim 1 further comprising:
utilizing the particular detection thread to retrieve previous access information for the particular memory location; and
comparing the access information to the previous access information.

4. The method of claim 1 further comprising:
dividing the memory size of the memory device of the multi-core computing machine into n equal parts, wherein n is the number of one or more created detection threads.

5. The method of claim 4 further comprising:
distributing the access information to the particular detection thread of the one or more detection threads based on which of the n equal parts of the divided memory device the particular memory location is located.

6. The method of claim 1 wherein a number of created one or more detection threads equals a number of cores in the multi-core computing machine.

7. The method of claim 1 wherein each of the one or more created detection threads executes a FastTrack data race detection algorithm from access information from a corresponding queue.

8. The method of claim 1 wherein the queue for each of the one or more created detection threads is a first-in-first-out queue.

9. A system for parallelize data race detection in multicore machines, the system comprising:
a processing device;
a plurality of processing cores; and
a non-transitory computer-readable medium storing instructions thereon, with one or more executable instructions stored thereon, wherein the processing device executes the one or more instructions to perform the operations of:
creating one or more detection threads;
generating a queue for each of the one or more created detection threads;
upon accessing of a particular memory location within a memory device by an application thread executing on at least one of the plurality of processing cores, distributing access information into the queue for a particular detection thread of the one or more detection threads; and
utilizing the particular detection thread to retrieve the access information from the queue for the particular detection thread.

10. The system of claim 9 wherein the queue is a local repository associated with the particular detection thread.

11. The system of claim 9 further comprising a hash filter.

12. The system of claim 9 wherein the plurality of processing cores comprises a many-core symmetric multiprocessor (SMP) machine.

13. The system of claim 9 wherein the one or more executable instructions further cause the processing device to perform the operations of:
utilizing the particular detection thread to retrieve previous access information for the particular memory location; and
comparing the access information to the previous access information.

14. The system of claim 9 wherein the one or more executable instructions further cause the processing device to perform the operations of:
dividing the memory size of the memory device of the multi-core computing machine into n equal parts, wherein n is the number of one or more created detection threads.

15. The system of claim 9 wherein the one or more executable instructions further cause the processing device to perform the operations of:
distributing the access information to the particular detection thread of the one or more detection threads based on which of the n equal parts of the divided memory device the particular memory location is located.

16. The system of claim 9 wherein a number of created one or more detection threads equals a number of cores in the multi-core computing machine.

17. The system of claim 9 wherein each of the one or more created detection threads executes a FastTrack data race detection algorithm from access information from a corresponding queue.

18. One or more non-transitory tangible computer-readable storage media storing computer-executable instructions for performing a computer process on a machine, the computer process comprising:
creating one or more detection threads within the multi-core computing machine;
generating a queue for each of the one or more created detection threads;
upon accessing of a particular memory location within a memory device of the multi-core computing machine by an application thread of the multi-core computing machine, distributing access information into the queue for a particular detection thread of the one or more detection threads; and
utilizing the particular detection thread to retrieve the access information from the queue for the particular detection thread.

19. The one or more non-transitory tangible computer-readable storage media storing computer-executable instructions of claim 18, the computer process further comprising:
utilizing the particular detection thread to retrieve previous access information for the particular memory location; and
comparing the access information to the previous access information.

20. The one or more non-transitory tangible computer-readable storage media storing computer-executable instructions of claim 18 wherein each of the one or more created detection threads executes a FastTrack data race detection algorithm from access information from a corresponding queue.
